(19) United States
(12) Patent Application Publication
(10) Pub. No.: US 2026/0274060 A1
(43) Pub. Date: Sep. 17, 2026

(54) HYBRID MODULE FOR A HYBRID DRIVE TRAIN OF A MOTOR VEHICLE

(71) Applicant: ZF Friedrichshafen AG, Friedrichshafen (DE)

(72) Inventors: Berthold SCHRAFF, Friedrichshafen (DE); Frank SAUTER, Meckenbeuren (DE); Mario HOLDER, Tettnang (DE); Hermann LANZ, Frickingen (DE); Sylva ROTHER, Kressbronn am Bodensee (DE); Horst LEICHSENRING, Meinheim (DE)

(73) Assignee: ZF Friedrichshafen AG, Friedrichshafen (DE)

(21) Appl. No.: 19/541,959

(22) Filed: Feb. 17, 2026

(30) Foreign Application Priority Data
Feb. 17, 2025 (DE) 10 2025 105 754.0

(51) Int. Cl. B60K 6/26; B60K 6/387; B60K 6/405

(52) U.S. Cl. CPC B60K 6/26; B60K 6/387; B60K 6/405

(57) ABSTRACT

A hybrid module (3) for a hybrid drivetrain (2) of a motor vehicle (1) includes a housing (4), an electric machine (6) arranged in an inside space (5) of the housing, and a power terminal (10) for supplying electricity to the electric machine (6). The housing (4) has a housing section (14) for the separation of the inside space (5) at the front. In this case, the housing section (14) defines at least one closeable cut-out (15) for the passage of at least one fastening means (16), which serves for the fitting of at least one current-carrying component (17) between the electric machine (6) and the power terminal (10) within the inside space (5).

### RELATED APPLICATIONS

This application claims the benefit of and right of priority under 35 U.S.C. § 119 to German Patent Application no. 10 2025 105 754.0, filed on 17 Feb. 2025, the contents of which are incorporated herein by reference in its entirety.

### FIELD OF THE DISCLOSURE

The invention relates to a hybrid module for a hybrid drivetrain of a motor vehicle. In addition, the invention relates to a motor vehicle with such a hybrid drivetrain.

### BACKGROUND

From DE 10 2007 008 098 A1 an electric connecting structure for connecting at least one power supply terminal to at least one motor-side terminal is known.

Screw joints for connecting the power terminal to a hybrid module of a motor vehicle drivetrain are usually made with separate openings on the radially outer circumference of a housing of the hybrid module. For this large side covers are used, which accordingly take up a lot of fitting space. The side covers have to be elaborately sealed and protected from access by a mechanic or fitter, since electrically ‘live’ components are hidden by the cover. For that purpose, expensive high-voltage interlock systems are usually integrated. Furthermore, large openings in the outer circumference of a housing weaken the structure of the housing. Consequently, to achieve durability, elaborate reinforcement measures have to be adopted, such as rib structures. These measures increase the cost of the system and add to its weight. Furthermore, even more fitting space is needed.

### SUMMARY

The purpose of the present invention is to propose a simply built and compact hybrid module for a motor vehicle hybrid drivetrain, whose ‘live’ current-carrying components are well protected from unauthorized access. A further objective is to propose a motor vehicle with an improved hybrid drivetrain.

These objectives are achieved by a hybrid module with the features specified disclosed herein, and by a motor vehicle having such a hybrid module. Further advantageous embodiments emerge from the present disclosure.

A hybrid module according to the invention for a hybrid drivetrain of a motor vehicle comprises a housing and an electric machine arranged in an inside space of the housing, and also a power terminal for supplying electricity to the electric machine. That electrical supply takes place in particular by way of electric leads connected to the hybrid module, in particular such as power cables. The housing of the hybrid module comprises a housing section, in particular extending essentially radially, which is designed for the spatial separation of the inside space at a front side of the housing. On the housing section at least one cut-out that can be closed is provided. The cut-out is designed to allow the passage of at least one fastening means, such that the fastening means serves for the fitting of at least one current-conducting component between the electric machine and the power terminal of the hybrid module.

Thus, the current-conducting component is in the current path between the electric machine and the power terminal. Accordingly, during the operation of the hybrid module, the current-conducting component serves to transmit electrical power between the power terminal and the electric machine.

Preferably, when the current-conducting component is fully mounted, the fastening means is arranged completely within the inside space. Preferably, the fastening means is a screw or bolt. The fastening means can be arranged in the current path between the electric machine and the power terminal and therefore can contribute to the transmission of electrical power between the power terminal and the electric machine.

The diameter of the cut-out is preferably adapted to the diameter of the fastening means in such manner that the fastening means passes through the cut-out with sufficient space at the sides for assembly and can be fixed through the cut-out. In particular the chosen size of the cut-out is such that a fastening means in the form of a screw can be inserted in the longitudinal direction of the screw completely through the cut-out into the inside space and can be tightened therein by means of a screwing tool inserted through the cut-out. The chosen size of the cut-out is preferably such that it can be closed by a closure element as small as possible. In particular, the diameter of the cut-out is smaller than three times or twice the maximum diameter of the fastening means, for example the diameter of the screw head of the fastening means.

In other words, the fastening means is introduced into the inside space of the housing through an end face of the hybrid module and through the associated cut-out, i.e., in an axial direction along a longitudinal axis of the hybrid module. The cut-out can be in the form of a bore or circular aperture whose axis extends parallel to a longitudinal axis of the hybrid module. In that way, protection against unauthorized or unsafe access can be ensured simply since the current-carrying components in the inside space of the housing are not accessible without elaborate dismantling measures on the hybrid module. In particular, in order to reach an end-face cut-out at all, at least one transmission module or a clutch module has to be dismantled from the hybrid module. Thereby it is ensured that the components that carry current during operation are no longer under high voltage. Consequently, there is no need for an expensive high-voltage interlock system since the cut-out is not directly accessible. Furthermore, thanks to the cut-out, no large openings in the radial outer circumference of the housing are needed, so that weakening of the structure of the housing is avoided.

All-in-all, by providing one or more such cut-outs in the end-face of the housing section, a more compact, simple-to-produce, and less costly hybrid drivetrain with sufficient protection for the assembly personnel is realized.

It should be noted that the electric leads or power cables for supplying electricity to the electric machine are not necessarily part of the hybrid module. They serve to supply electricity, i.e., electrical energy to the hybrid module, for example from an inverter or an electric traction battery of the motor vehicle. The power cables are in particular high-voltage cables.

The housing section in which the cut-out is made preferably extends essentially in the radial direction. Thus, the housing section can form a closure of the inside space at its end. The housing section is in particular a bearing shield of the hybrid module for the rotatable mounting of a shaft of the hybrid module. In that way, the cut-out can be made in a flattened area of the housing section, in the wall of the housing.

The housing of the hybrid module preferably comprises a clutch bell. This serves for the spatial accommodation of at least one clutch release mechanism of a separator clutch outside the inside space of the hybrid module, in which the electric machine is located. The separator clutch is in particular drivingly connected between the hybrid module and a combustion engine of the hybrid drivetrain. The separator clutch is specifically a starter clutch for the combustion engine. The clutch bell contains the housing section, wherein the housing section is designed to separate the separator clutch spatially from the inside space of the housing. By virtue of the housing section, in particular, any penetration of dirt from the clutch bell into the inside space is prevented, for example due to wear of the separator clutch. In particular, the housing section forms a bearing shield for an input shaft of the hybrid module.

Preferably, the hybrid module also comprises an electromagnetic compatibility (EMC) filter. The EMC filter is arranged within the inside space and is designed such that in the assembled condition the fastening means extends at least partially through the EMC filter. In particular, the EMC filter is arranged radially outside the electric machine. Such an EMC filter is a component which reduces interference in the form of electromagnetic waves or high-frequency currents in order to satisfy the requirements of electromagnetic compatibility (EMC). In hybrid drives, which combine electrical and mechanical energy sources, high-frequency interferences due to the power electronics and the electric drive are produced, for example by switching processes of power transistors, and these effects can influence other electronic systems in the vehicle. The EMC filter can eliminate these interferences or reduce them by a necessary amount. Since the EMC filter surrounds a conductor section between the power terminal and the electric machine, the electromagnetic compatibility is improved. For each electric phase of the electric machine, just one such EMC filter can be provided.

Preferably, the fastening means is provided in order to attach a connection strip emerging from the electric machine to a first connection bolt which passes through the EMC filter. For that purpose, in particular, the first connection bolt has an internal thread into which, during assembly, the fastening means is screwed through the cut-out. The first connection bolt is a current-carrying component which serves, after the fixing by means of the fastening means, to connect the electric connection strip at least indirectly to the associated electric lead or connection cable. By virtue of the first connection bolt concerned, in particular tolerance compensation is achieved since such connection strips of the electric machine are comparatively inflexible. Specifically, for each electric phase of the electric machine just one such connection strip, just one first connection bolt and just one fastening means are provided, which serve for the connection of the respective connection strip. In particular the connection strip emerges from a stator of the electric machine. In particular, the connection strip projects radially outward on a winding head at the end of the stator.

Preferably, on the housing section at least or exactly three cut-outs for the passage of such fastening means are provided, each of which serves for the fitting of a current-carrying component between the electric machine and the power terminal within the inside space of the housing. The cut-outs can be arranged spaced uniformly in the circumferential direction of the hybrid module and are located essentially an identical radial distance from a longitudinal axis of the hybrid module. The at least or exactly three cut-outs are provided in order to allow the passage in each case of an associated fastening means during assembly. When fitted, each fastening means connects an associated connection strip of the electric machine to an associated first connection bolt, both mechanically and in an electrically conducting manner. Correspondingly, three electric leads or conducting cables can be provided, which are electrically connected to the electric machine via the power terminal and current-carrying components within the inside of the housing.

In an embodiment, the cut-out is designed so that it can be closed by an associated closure device, such as a closure screw or a closure plug. In other words, each cut-out is designed to receive a complementarily designed closure device. For that purpose, the cut-out can have a thread. By using simple and suitable closure screws or closure plugs the protection against inadvertent contact with current-carrying components can be improved further. The closure screw or closure plug also has a sealing effect to protect the inside space of the hybrid module from external influences. Preferably, it is provided that the cut-out guides the closure screw or the closure plug in the axial direction in the direction toward the inside space and is sealed thereby in a leak-proof manner.

Also preferably, an essentially radially extending second connection bolt is provided. This second connection bolt is fixed on a power terminal housing connected to the housing of the hybrid module. The second connection bolt projects out of the inside space, in particular extending out in the radial direction. Outside the inside space the second connection bolt is designed to make electrical contact with an electric lead which serves to supply the electric machine with electricity. This electric lead is in particular one of the power cables. Thus, the second connection bolt can serve to connect the power cable electrically to the hybrid module. In that way, the electrical connection between the power cable and the electric machine in the inside space of the hybrid module, i.e., on the associated connection strip of the electric machine, can be formed of more than one part. The second connection bolt leads from the power connection housing into the inside space of the hybrid module. For that purpose, in particular the second connection bolt is sealed and insulated relative to the housing of the hybrid module.

The second connection bolt is preferably connected directly to the associated first connection bolt, for example these being screwed or welded to one another. In that way, the number of electric contacts in the inside space of the hybrid module that have to be made during the assembly of the hybrid module for electrical connection to the electric machine is greatly reduced, which substantially simplifies the assembly process. In particular, the first and second connection bolts extend at a right-angle to one another. Specifically, the first connection bolt extends axially relative to the hybrid module, and the second connection bolt extends radially relative to the hybrid module. In particular, the connection point of the first and second connection bolts is in the area of ends of the connection bolts.

The power connection housing serves in particular to protect and/or to enclose the electrical connection point between the second connection bolt and the associated electric lead which serves to supply electricity to the electric machine, as does in particular the power cable. The power connection housing can be sealed relative to the surroundings, or it can be made open. The power connection housing can be provided on a radially outer side of the housing of the hybrid module. The power connection housing can be made integrally with the housing. The power connection housing can be closed by a cover, the cover being designed to cover the connection point between the second connection bolt and the lead for supplying electricity to the electric machine. Thus, when the cover is removed, this connection point can be made or separated, as necessary. The cover of the power connection housing can have a projection extending in the axial direction or the circumferential direction of the hybrid module, to which projection the electric lead is attached. This attachment of the electric lead to the projection can be axially a distance away from a sealed passage of the electric lead into the power connection housing, in which the lead is connected to the second connection bolt. By attaching the electric lead for supplying electricity to the electric machine to the projection, bending, tension or shear forces on the seal of the lead in the area of the passage can be reduced or prevented, since it is already fully or partially supported by the projection. The mechanical loading of the seal can be reduced in that way, and its durability improved.

The invention also relates to a motor vehicle comprising a hybrid drivetrain with a hybrid module as described above. The motor vehicle can have one or more such drivetrains. The hybrid drivetrain can comprise a differential or it can be connected to a differential on an axle of the motor vehicle, whereby the differential can divide a drive power of the hybrid drivetrain between drive wheels of the axle concerned. The hybrid drivetrain can also comprise a transmission module and/or a clutch module. The transmission module and/or clutch module can each be attached at an end of the hybrid module. Preferably, the transmission module and the clutch module can be attached at opposite ends of the hybrid module. The transmission module can have a plurality of optionally engaged gear ratios (gears). The clutch module can comprise a separator clutch for drivingly coupling and decoupling a combustion engine to the hybrid module and the transmission module.

The above definitions and descriptions regarding technical effects, advantages and advantageous embodiments of the hybrid module according to the first aspect, also apply analogously to the motor vehicle according to the invention according to the second aspect of the invention, and conversely. Terms that denote spatial directions, such as “radial” or “axial”, relate in each case to a main axis of the hybrid module unless otherwise indicated.

### BRIEF DESCRIPTION OF THE DRAWINGS

Below, a preferred embodiment of the invention is explained in greater detail with reference to the figures, which show:

FIG. 1: A schematic view from above, of a motor vehicle comprising a hybrid drivetrain,

FIG. 2: A schematic perspective representation of a hybrid module, and

FIG. 3: A schematic longitudinally sectioned representation of the hybrid module shown in FIG. 2.

### DETAILED DESCRIPTION

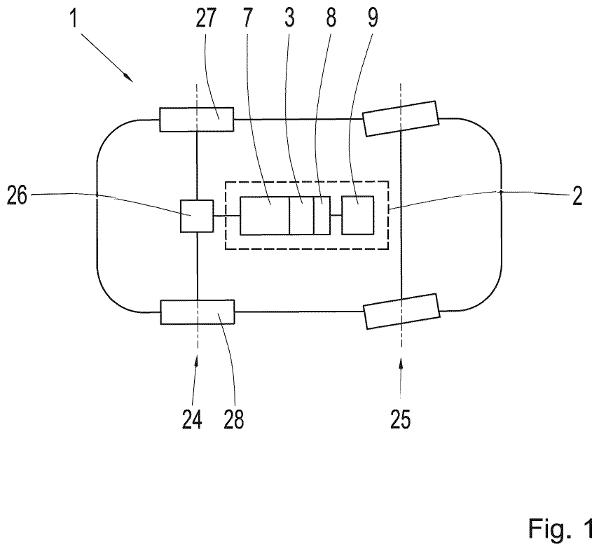

FIG. 1 shows, very schematically, a motor vehicle 1 seen from above. The motor vehicle 1 comprises a first axle 24 as its rear axle and a second axle 25 as a steered front axle, wherein the first axle comprises a hybrid drivetrain 2 which is functionally connected to a differential 26. The differential 26 divides the drive power of the drivetrain, i.e. a rotation speed and a torque, between wheels 27, 28 of the first axle 24.

The drivetrain 2 is constructed in a modular manner, with modules axially one behind another. According to FIG. 1, the drivetrain 2 shown as an example comprises a transmission module 7 and a clutch module 8 with a separator clutch for the optional coupling and decoupling of a combustion engine 9 to or from the transmission module 7, depending on the operating condition at the time. Thus, the combustion engine can be used as the drive for the drivetrain 2.

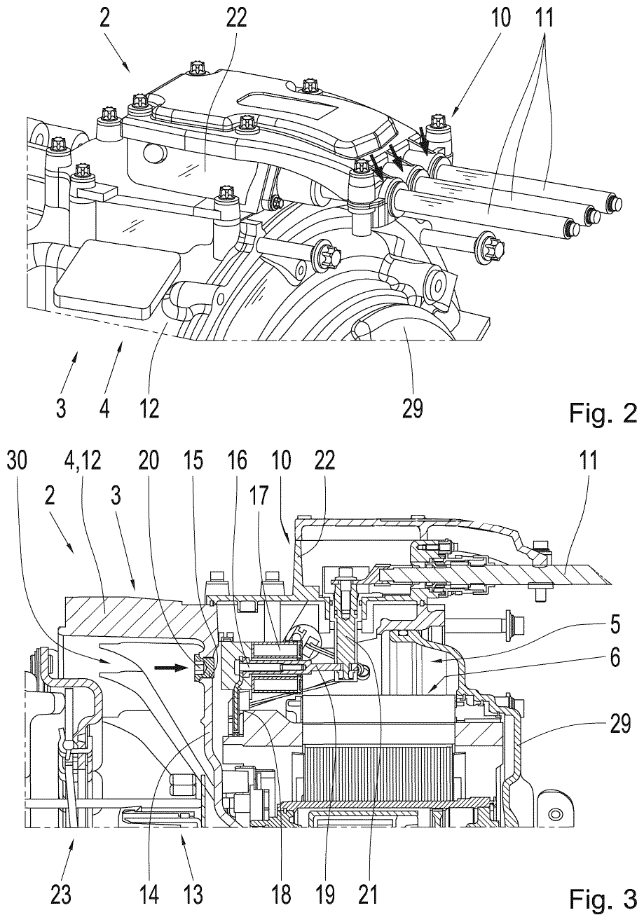

Spatially between the transmission module 7 and the clutch module 8 is arranged a hybrid module 3. The hybrid module 3 has a first end side associated with the clutch module 8 (the drive input side) and a second end side associated with the transmission module 7 (the drive output side). The hybrid module contains the electric machine 6 that can be seen in FIGS. 2 and 3, which can be used as a further drive for the drivetrain 2. In that way, the drive power provided by the combustion engine 9 can be dispensed with at least some of the time, and/or the combustion engine 9 can be supported by the electric motor. Furthermore, the electric machine 6 can be operated as a generator. For the sake of clarity, the electric machine 6 is not shown in FIG. 1. It is located in the inside space 5 of the hybrid module 3, clearly visible in FIG. 2.

According to FIGS. 2 and 3 the hybrid module 3 shown as an example comprises a multi-component housing 4 and the electric machine 6 located in the inside space 5 of the housing 4. The inside space 5 is preferably sealed relative to the surroundings of the hybrid module 3. At its end on the drive input side the housing 4 of the hybrid module 3 has a clutch bell 12 for the at least partial spatial accommodation of the separator clutch 23 of the clutch module 8, in particular that of a clutch release mechanism 13 of the separator clutch 23. The housing 4 also has on its drive output side a cover 29 which closes off the inside space 5 of the hybrid module 3 on that side. In that way the hybrid module 3 is spatially separated from the transmission module 7.

The cover 29 can be designed to be introduced into a clutch bell of the transmission module 7. In this case the clutch bell of the transmission module 7 itself does not have to accommodate a clutch. It can be provided that the clutch bell of the transmission module 7 is designed to accommodate the separator clutch 23 if the hybrid module 3 is omitted from the drivetrain 2.

The separator clutch 23 is for example a single-disk dry clutch. The separator clutch 23 is provided for coupling and decoupling the combustion engine 9 to or from the hybrid module 3 and therefore also the transmission module 7, depending on the operating situation.

Furthermore, a power terminal 10 arranged on the hybrid module 3 is provided for the electrical connection of the electric machine 6 in the inside space 5 of the housing 4 of the hybrid module 3 to electrical leads 11, which serve to supply the electric machine 6 with electricity and which, for that purpose, are inserted into the hybrid module 3 from the outside. In the example shown these leads 11 are power cables. For the purpose, the power terminal 10 has a power terminal housing 22 radially on the outside of the housing 4, on which the leads 11 are clamped and/or supported. The power terminal housing 22 is for example made integrally with the rest of the housing 4 of the hybrid module 3. In particular, exactly one such electric lead 11 is provided for each electric phase of the electric machine 6. In the example shown in FIGS. 2 and 3 the electric machine 6 is a three-phase machine, so that precisely three leads 11 are provided-namely just one for each electric phase. With a different number of electric phases of the electric machine 6 the number of electric leads 11 used for its supply can be varied correspondingly.

As can be seen in the upper portions of FIGS. 2 and 3, the power terminal housing 22 preferably comprises a cover which has a forward-protruding projection. This projection serves to support the leads 11 before they pass into the power terminal housing 22. In particular, for that purpose the leads 11 are attached, specifically clamped, to the projection of the cover in the area of the arrows visible in FIG. 2. As also shown in FIG. 2, the cover can be screwed to the rest of the power terminal cover 22 so that it closes the latter.

FIG. 3 shows, for example, that the clutch bell 12 is bowl-shaped. The clutch bell 12 comprises an essentially radially extending housing section 14 for the spatial separation of an inside space 30 of the clutch bell 12, in which the separator clutch 23 is located, from the aforesaid inside space 5 of the hybrid module 3. On the housing section 14 closeable cut-outs 15 in the form of bores are provided, for the axial insertion of a fastening means 16 in each case. The fastening means 16 are in particular screws. Each of the cut-outs 15 can be closed by means of an associated complementary closure device, for example a closure screw 20 or a closure plug. For that purpose, when closure screws are used for the closing the cut-outs 15 can have an internal thread. The diameter of the cut-outs 15 is chosen such that each corresponding fastening means 16 can be inserted in its longitudinal direction through the cut-out 15 and fixed within the inside space. However, the diameter of the cut-outs 15 is not chosen essentially larger, so that the weakening caused by the diameter of the closure 20 and that of the cut-outs 15 remains as small as possible.

During the assembly of the hybrid drivetrain 2, particularly during the fitting of the power terminal 10 to the electric machine 6, the fastening means 16 are inserted in the axial direction, via the inside space 30 of the clutch bell 12, through the cut-outs 15 and connected, for example screwed, to an associated first connection bolt 10 in the inside space 5. In this case a respective connection strip 18 extending radially away from the electric machine 6 is connected fast to the associated first connection bolt 19. Thus, the fastening means 16 are provided for the fitting of current-carrying components between the electric machine 6 and the leads 11, After the fastening means 16 have been fixed in the cut-outs 15 the closures 20 are fitted, for example screwed in, and thereby seal the inside space 5 of the housing 4 relative to the inside space 30 of the clutch bell 12.

Radially outside the electric machine 6 an EMC filter 17 is arranged in the inside space 5. The EMC filter 17 is designed to surround the respective first connection bolt 19 radially. The EMC filter 17 serves to improve the electromagnetic compatibility (EMC) of the system. In other words, when in the assembled condition shown in FIGS. 2 and 3 each of the first connection bolts 19 passes axially though the EMC filter 17. All the first connection bolts 19 can pass conjointly though a common EMC filter or each of them can pass through an EMC filter 17 of its own.

In the inside space 5 the axially extending first connection bolts 19 are electrically connected to an associated radially extending second connection bolt 21. Preferably, each first connection bolt 19 is connected directly to the respectively associated second connecting bolt 21. For example, as shown in FIG. 2, they are screwed to one another although other forms of connection are also possible. The second connection bolt 21 projects radially out of the inside space 5 into the power terminal housing 22. The second connection bolt 21 is electrically insulated relative to the housing 4. Inside the power terminal housing 22 the second connection bolt 21 is in turn electrically connected directly to the respectively associated electric lead 11 for supplying electricity to the electric machine 6. The second connection bolt 21 can be attached to the power terminal housing 22.

Thus, each of the preferably three electric leads Il can be connected in an electrically conducting manner, via a second connection bolt 21, a first connection bolt 19 and a connection strip 18, to the electric machine 6. As described above, whereas in this case the connection strip 18 is connected electrically to the associated connection bolt 19 inside the inside space 5, this is done via the clutch bell 12. In other words, the fitting of the fastening means 16 and the closure screws 20 takes place from inside the clutch bell 12, i.e. from the side of the housing section 14 facing away from the inside space 5.

### INDEXES

1 Motor vehicle
2 Hybrid drivetrain
3 Hybrid module
4 Housing of the hybrid module
5 Inside space of the housing
6 Electric machine
7 Transmission module
8 Clutch module
9 Combustion engine
10 Power terminal
11 Lead, power cable
12 Clutch bell
13 Clutch release mechanism
14 Housing section
15 Cut-out
16 Fastening means, screw
17 EMC filter
18 Connection strip
19 First connection bolt
20 Closure device, closure screw
21 Second connection bolt
22 Power terminal housing
23 Separator clutch
24 First axle
25 Second axle
26 Differential
27 Wheel
28 Wheel
29 Cover
30 Inside space of the clutch bell

1. A hybrid module (3) for a hybrid drivetrain (2) of a motor vehicle (1), comprising:
a housing (4);
an electric machine (6) arranged in an inside space (5) of the housing (4); and
a power terminal (10) configured for supplying the electric machine (6) with electricity,
wherein the housing (4) has a housing section (14) separating the inside space (5) at a front end, and
wherein on the housing section (14) at least one closeable cut-out (15) is defined to allow the passage of at least one fastening means (16), which serves for the fitting of at least one current-carrying component (17) between the electric machine (6) and the power terminal (10) in the inside space (5).

2. The hybrid module (3) according to claim 1, wherein the housing section (14) extends essentially radially.

3. The hybrid module (3) according to claim 1, wherein the housing (4) has a clutch bell (12) configured for the spatial accommodation of at least one clutch release mechanism (13) of a separator clutch (23) arranged outside the inside space (5), and wherein the clutch bell (12) contains the housing section (14) for the spatial separation of the separator clutch (23) from the inside space (5) of the hybrid module (3).

4. The hybrid module (3) according to claim 1, comprising an EMC filter (17) within the inside space (5), wherein in an assembled condition, the at least one fastening means (16) extends at least partially through the EMC filter (17).

5. The hybrid module (3) according to claim 4, wherein the at least one fastening means (16) is configured to attach a first connection bolt (19) to a connection strip (18) emerging from a part of the electric machine (6) that passes through the EMC filter (17).

6. The hybrid module (3) according to claim 5, wherein the housing section (14) defines at least or exactly three cut-outs (15) for the passage of the at least one fastening means (16), wherein each at least one fastening means (16) is configured for fitting of a current-carrying component between the electric machine (6) and the power terminal (10) in the inside space (5).

7. The hybrid module (3) according to claim 6, wherein the cut-out (15) is configured to be closed by a closure screw (20) or a closure plug.

8. The hybrid module (3) according to claim 7, comprising a second connection bolt (21) attached to a power terminal housing (22) connected to the housing (4) of the hybrid module (3), wherein the second connection bolt (21) extends out of the inside space (5) and is configured to make electrical contact with an electric lead (11) outside the inside space (5) for the supply of electricity to the electric machine (6).

9. The hybrid module (3) according to claim 8, wherein the second connection bolt (21) is connected directly to the first connection bolt (19).

10. A motor vehicle (1) comprising a hybrid drivetrain (2) with a hybrid module (3) according to claim 1.
